(19) United States
(12) Patent Application Publication
(10) Pub. No.: US 2018/0075195 A1
(43) Pub. Date: Mar. 15, 2018

(54) SYSTEM AND METHOD FOR FACILITATING COMPUTER-ASSISTED HEALTHCARE-RELATED OUTLIER DETECTION

(71) Applicant: KONINKLIJKE PHILIPS N.V., Eindhoven (NL)

(72) Inventors: Yang YANG, Medford, MA (US); Yugang JIA, Winchester, MA (US); Wei WANG, Somerville, MA (US); Reza SHARIFI SEDEH, Malden, MA (US)

(21) Appl. No.: 15/685,318

(22) Filed: Aug. 24, 2017

Related U.S. Application Data
(60) Provisional application No. 62/394,796, filed on Sep. 15, 2016.

(51) Int. Cl. G06F 19/00; G06Q 10/06; G06F 17/18

(52) U.S. Cl. CPC G06F 19/327; G06F 17/18; G06Q 10/06393; G06F 19/324

(57) ABSTRACT

The present disclosure pertains to a method and system configured for facilitating computer-assisted healthcare-related outlier detection via automated threshold-based contributing factor detection. The system comprises at least one processor configured to obtain contributing factor candidates for one or more healthcare-related metrics; process a collection of healthcare records associated with an entity to assess the one or more healthcare-related metrics with respect to the entity; determine, a healthcare-related metric having a value that satisfies an outlier detection threshold; determine one or more subsets of contributing factors from the contributing factor candidates; modify one or more weights associated with the one or more subsets of contributing factors; and reprocess the collection of healthcare records to reassess the one or more healthcare-related metrics with respect to the entity and the extent of impact of at least some of the contributing factor candidates on the one or more healthcare-related metrics.

### CROSS-REFERENCED APPLICATIONS

This application claims the benefit of U.S. Patent Application No. 62/394,796, filed on 2016 Sep. 15. This application is hereby incorporated by reference herein.

### BACKGROUND

### 1. Field

The present disclosure pertains to a system and method for facilitating computer-assisted healthcare-related outlier detection.

### 2. Description of the Related Art

Studies have shown a great clinical need for automatic derivations of outlier detection rules and identification of meaningful outliers in clinical research. Circumstances that need automatic outlier detection include identifying outliers in brain images, outliers in cardio echo diagrams, outliers of extremely expensive prescription and outliers of primary care physician in a region. Specifically, for example, with regards to a regional primary care physician (PCP)'s performance in one fiscal year, the total volume of expenditure patients spent with him, the percentage of patient leakage from him, and the percentage of avoidable cost he was responsible for, are all interesting key performance indicators (KPIs) to evaluate the performance of PCP. Outliers in any KPI scale are of high interest to users. Furthermore, the intersection of outliers by all KPIs and the common trigger conditions are even more valuable. The identified outliers can be engaged for the purpose of either exclusion or investigation. Exclusion of outliers will lead to a more homogeneous study sample pool and benefit follow-up analysis. Investigation into outliers includes engaging with outliers, for example, PCPs to promote their performance so they are not outliers any more in the next year. Further, the identification of trigger conditions, i.e., those meaningful predictors significantly associated with the occurrence of an outlier, are of equal importance.

Drafting the outlier detection rules based on a reliable set of triggering conditions is laborious and knowledge-intensive. Besides, very few clinical facilities adopt the same outlier detection rules for the same clinical problem due to their unique local characteristics. Further, the drafted outlier detection rules and the automatically identified outliers based on the outlier detection rules need the clinical experts' review to determine if they are appropriate. If it is determined by the clinical experts that the drafted outlier detection rules and the automatically identified outliers are inappropriate, the potential solutions for improvement have to be transformed into a machine-readable metrics for the automatic process to learn and improve its accuracy. Therefore, there is a need to establish a pipeline to automatically generate a reliable set of triggering conditions, derive the outlier detection rules, identify the outliers on multiple KPI scales, and adjust the set of triggering conditions and/or the multiple KPI scales for more meaningful identification of the outliers.

### SUMMARY

Accordingly, one or more aspects of the present disclosure relate to a system for facilitating computer-assisted healthcare-related outlier detection via automated threshold-based contributing factor detection. The system comprises at least one processor configured by machine-readable instructions to obtain contributing factor candidates for one or more healthcare-related metrics; process, based on the contributing factor candidates, a collection of healthcare records associated with an entity to assess the one or more healthcare-related metrics with respect to the entity and an extent of impact of at least some of the contributing factor candidates on the one or more healthcare-related metrics, the collection of healthcare records including a set of values associated with each of the contributing factor candidates; determine, based on the processing of the collection of healthcare records, a healthcare-related metric having a value that satisfies an outlier detection threshold associated with the healthcare-related metric; determine, based on the processing of the collection of healthcare records, one or more subsets of contributing factors from the contributing factor candidates, wherein the one or more subsets of contributing factors include one or more values that satisfy an impact threshold associated with the healthcare-related metric; modify one or more weights associated with the one or more subsets of contributing factors; and reprocess, based the one or more modified weights, the collection of healthcare records to reassess the one or more healthcare-related metrics with respect to the entity and the extent of impact of at least some of the contributing factor candidates on the one or more healthcare-related metrics.

Yet another aspect of the present disclosure relates to a method implemented on a system for facilitating computer-assisted healthcare-related outlier detection via automated threshold-based contributing factor detection. The method comprises obtaining, with at least one processor, contributing factor candidates for one or more healthcare-related metrics; processing, with the at least one processor, based on the contributing factor candidates, a collection of healthcare records associated with an entity to assess the one or more healthcare-related metrics with respect to the entity and an extent of impact of at least some of the contributing factor candidates on the one or more healthcare-related metrics, the collection of healthcare records including a set of values associated with each of the contributing factor candidates; determine, based on the processing of the collection of healthcare records, a healthcare-related metric having a value that satisfies an outlier detection threshold associated with the healthcare-related metric; determine, based on the processing of the collection of healthcare records, one or more subsets of contributing factors from the contributing factor candidates, wherein the one or more subsets of contributing factors include one or more values that satisfy an impact threshold associated with the healthcare-related metric; modifying, with the at least one processor, one or more weights associated with the one or more subsets of contributing factors; and reprocessing, with the at least one processor, based the one or more modified weights, the collection of healthcare records to reassess the one or more healthcare-related metrics with respect to the entity and the extent of impact of at least some of the contributing factor candidates on the one or more healthcare-related metrics.

Still another aspect of the present disclosure relates to a system for facilitating computer-assisted healthcare-related outlier detection via automated threshold-based contributing factor detection. The system comprises means for means for obtaining, with at least one processor, contributing factor candidates for one or more healthcare-related metrics; means for processing, with the at least one processor, based on the contributing factor candidates, a collection of healthcare records associated with an entity to assess the one or more healthcare-related metrics with respect to the entity and an extent of impact of at least some of the contributing factor candidates on the one or more healthcare-related metrics, the collection of healthcare records including a set of values associated with each of the contributing factor candidates; means for determining, with the at least one processor, based on the processing of the collection of healthcare records, a healthcare-related metric having a value that satisfies an outlier detection threshold associated with the healthcare-related metric; means for determining, with the at least one processor, based on the processing of the collection of healthcare records, one or more subsets of contributing factors from the contributing factor candidates, wherein the one or more subsets of contributing factors include one or more values that satisfy an impact threshold associated with the healthcare-related metric; means for modifying, with the at least one processor, one or more weights associated with the one or more subsets of contributing factors; and means for reprocessing, with the at least one processor, based the one or more modified weights, the collection of healthcare records to reassess the one or more healthcare-related metrics with respect to the entity and the extent of impact of at least some of the contributing factor candidates on the one or more healthcare-related metrics.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates an exemplary configuration of an outlier detection server for facilitating computer-assisted healthcare-related outlier detection, in accordance with an embodiment of the present teaching;

FIG. 2 illustrates an exemplary flowchart for facilitating computer-assisted healthcare-related outlier detection, in accordance with an embodiment of the present teaching;

FIG. 3 illustrates another exemplary flowchart for facilitating computer-assisted healthcare-related outlier detection, in accordance with an embodiment of the present teaching; and

FIG. 4 illustrates an exemplary system for facilitating computer-assisted healthcare-related outlier detection, in accordance with another embodiment of the present teaching.

### DETAILED DESCRIPTION OF EXEMPLARY EMBODIMENTS

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

Throughout the specification and claims, terms may have nuanced meanings suggested or implied in context beyond an explicitly stated meaning. Likewise, the phrase “in one embodiment/example” as used herein does not necessarily refer to the same embodiment and the phrase “in another embodiment/example” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present teaching describes a system and method that facilitates computer-assisted healthcare-related outlier detection via automated threshold-based contributing factor detection. The system automatically derives the meaningful outlier detection rules and identifies the outliers in accordance with the derived rules. In particular, one or more KPIs are used to generate the healthcare-related metrics for outlier detection. For example, to assess the performance of a regional primary care physician (PCP) in one fiscal year, three KPIs may be defined including the total volume of expenditure patients spent with the PCP, the percentage of patient leakage from the PCP, and the percentage of avoidable cost the PCP was responsible for. Outliers defined for this situation are the PCPs with extremely low or high KPI values (two-sided assessment) or only extremely high KPI values (one-sided assessment). One or more combinations of factors which contribute to be identified as outliers are called triggering conditions of outliers. For example, the PCPs in cardiovascular disease service line, aged between 50 and 65, and located within zip code 02141 tend to produce much higher total volume of patient expenditures and much higher percentage of avoidable cost per year than other PCPs. According to the defined outlier detection rules, those PCPs are identified as outliers with respect to these two KPIs.

With multiple KPIs pre-defined by the user, the common outliers and the common triggering conditions for more than one KPIs are more valuable. The system collects contributing factor candidates using customized feature engineer process facilitated by the user. When the contributing factor candidates are ready, general linear or non-linear based feature selection algorithm are utilized to determine one or more subsets of significant contributing factors associated with the one or more KPIs. A common set of the contributing factors associated with all KPIs and one or more additional contributing factors uniquely associated with one of the one or more KPIs are derived.

Further, a specific value range of each contributing factor, which leads to extremely high or low KPI is determined to facilitate search space reduction. According to the present disclosure, multivariate outlier detection algorithms including but not limited to angle-based, density-based, distance-based methods are applied to identify the outliers characterized by the one or more subsets of contributing factors. The identified outliers are reassessed based on the extent of impact of the contributing factors on the one or more KPIs. If it is determined that some contributing factors are not clinically meaningful, the weights associated with those contributing factors are adjusted or removed from the contributing factor selection process. Outlier detection is re-executed based on the adjusted contributing factors associated with the KPIs. The method and system according to the present disclosure identifies meaningful outliers on multiple KPI scales and locks on those meaningful trigger conditions which lead to outliers. The trigger conditions are potentially valuable to put into actions for performance monitoring and improvement so that present outliers are remedied.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

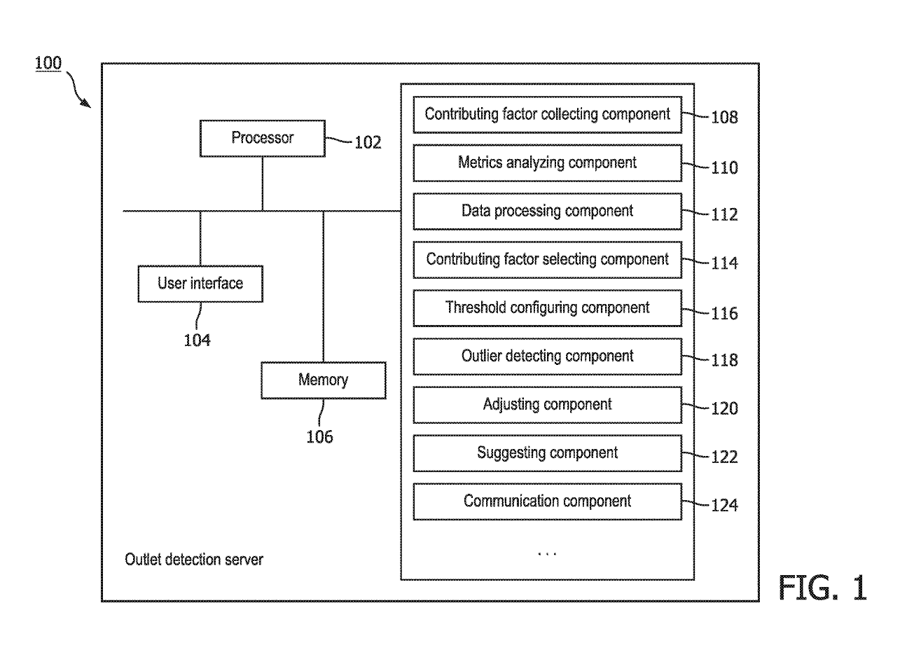

FIG. 1 illustrates an exemplary configuration of an outlier detection server for facilitating computer-assisted healthcare-related outlier detection, in accordance with an embodiment of the present teaching. The outlier detection server 100 comprises at least one processor 102, a user interface 104, a memory 106, a contributing factor collecting component 108, a metrics analyzing component 110, a data processing component 112, a contributing factor selecting component 114, a threshold configuring component 116, an outlier detecting component 118, an adjusting component 120, a suggesting component 122, and a communication component 124.

Processor 102 is operatively communicated with user interface 104 and memory 106. Processor 102 may include one or more of a digital processor(s), analog processor(s), a digital circuit designed to process information, an analog circuit designed to process information, a state machine, a transmitter, a receiver, and/or other mechanism(s) or processor(s) for electronically processing information. Although processor 102 is shown in FIG. 1 as a single entity, this is for illustrative purposes only. In some embodiments, processor 102 may include one or more processing units. The one or more processing units may be physically located within a same device. Further, processor 102 may be configured to execute one or more computer program components including contributing factor collecting component 108, metrics analyzing component 110, data processing component 112, contributing factor selecting component 114, threshold configuring component 116, outlier detecting component 118, adjusting component 120, suggesting component 122, and communication component 124. Processor 102 may be configured to execute components 108, 110, 112, 114, 116, 118, 120, 122 and 124 by software; hardware; firmware; some combination of software, hardware, and/or firmware; and/or other mechanisms for configuring processing capabilities on processor 102.

Each of the one or more computer programmed components comprises a set of algorithms implemented on processor 102 that instructs processor 102 to perform one or more functions related to generating the statements, and/or other operations. For example, contributing factor collecting component 108 comprises algorithms implemented on processor 102 that instruct processor 102 to obtain a plurality of contributing factor candidates for one or more healthcare-related metrics; metrics analyzing component 110 comprises algorithms implemented on processor 102 that instruct processor 102 to analyze the operation data and determine one or more healthcare-related metrics; data processing component 112 comprises algorithms implemented on processor 102 that instruct processor 102 to process the healthcare-related records associated with an entity to assess the one or more healthcare-related metrics with respect to the entity; contributing factor selecting component 114 comprises algorithms implemented on processor 102 that instruct processor 102 to determine one or more subsets of contributing factors from the plurality of contributing factor candidates for outlier detection; threshold configuring component 116 comprises algorithms implemented on processor 102 that instruct processor 102 to configure the outlier detection threshold to identify an outlier entity and an impact threshold to select the one or more subset of contributing factors; outlier detecting component 118 comprises algorithms implemented on processor 102 that instruct processor 102 to identify the outlier entity based on the outlier detection threshold and the one or more subset of contributing factors; adjusting component 120 comprises algorithms implemented on processor 102 that instruct processor 102 to reprocess the one or more subset of contributing factors to reassess the one or more healthcare-related metrics with respect to the identified entity; suggesting component 122 comprises algorithms implemented on processor 102 that instruct processor 102 to modify one or more weights associated with the one or more subset of contributing factors for the reassessment; and communication component 124 comprises algorithms implemented on processor 102 that instruct processor 102 to communicate with the entities associated with a network.

It should be appreciated that although components 108, 110, 112, 114, 116, 118, 120, 122, and 124 are illustrated in FIG. 1 as being co-located with a single processing unit, in implementations in which processor 102 includes multiple processing units, one or more of these components may be located remotely from the other components. The description of the functions provided by the different components 108, 110, 112, 114, 116, 118, 120, 122, and 124 described below is for illustrative purposes, and is not intended to be limiting, as any of components 108, 110, 112, 114, 116, 118, 120, 122, and 124 may provide more or less functions than is described. For example, one or more of components 108, 110, 112, 114, 116, 118, 120, 122, and 124 may be eliminated, and some or all of its functions may be provided by other ones of components 108, 110, 112, 114, 116, 118, 120, 122, and 124. As another example, processor 102 may be configured to execute one or more additional components that may perform some or all of the functions attributed below to one of components 108, 110, 112, 114, 116, 118, 120, 122, and 124.

User interface 104 is configured to provide an interface between outlier detection server 100 and a user. The user launches an outlier detection application via user interface 104. During executing the outlier detection application, outlier detection server 100 presents the executed results at different stages on user interface 104 to allow the user to interact with the executed results. For example, a plurality of healthcare-related metrics is presented on user interface 104 that allows the user to select one or more healthcare-related metrics to evaluate an entity. The entity according to the present disclosure can be an individual entity, a group entity, an organization, or other entity. The individual entity may include a primary care physician or a sole-practice specialist. A group entity includes a group of physicians. An organization includes a hospital, a medical research center, and the affiliations of the hospital or the medical research center. The healthcare-related metric according to the present disclosure is a user-defined key performance indicator (KPI) to assess the operating performance of an entity. For example, a total volume of expenditure patients spent with a PCP, a percentage of patient leakage from the PCP, and a percentage of avoidable cost the PCP is responsible for are defined as three KPIs to evaluate the performance of the PCP during one fiscal year. It should be appreciated that the above KPI examples are for illustrative purpose and the present disclosure is not intended to be limiting. The KPIs are defined to accommodate various research needs. For example, a percentage of new patients of the PCP and patient adherence data indicative of the patient's adherence level to the treatment provided by the PCP and/or the medications prescribed by the PCP can be defined as the KPIs.

In some embodiments, one or more subsets of contributing factors are presented on user interface 104 with graphical illustration of the extent of impact of the one or more subsets of contributing factors on the one or more healthcare-related metrics. The contributing factors according to the present disclosure are factors related or contributing to the one or more healthcare-related metrics, i.e., KPIs. For example, clinical charge and on-site lab work are two factors that contribute to the total volume of expenditure patients spent with a PCP. In another example, physician follow-up times, age of the patients, and clinic location change are two factors that contribute to the percentage of patient leakage from the PCP. In yet another example, age of the patients, pre-existing conditions of the patients, and service provided to the patients are three factors that contribute to the percentage of avoidable cost the PCP is responsible for. The subset of contributing factors for each healthcare-related metric (i.e., KPI) is selected individually with respect to a given KPI. The subsets of contributing factors for various KPIs may have one or more common contributing factors. That is, the subsets of contributing factors may overlap to certain extent. It should be appreciated that the above examples of contributing factors are for illustrative purpose and the present disclosure is not intended to be limiting.

In another embodiment, the assessment results are presented on user interface 104 that allows the user to modify one or more weights associated with the one or more subsets of contributing factors for reassessment. For example, the presentation of the assessment results may include a graphical illustration of the KPIs with value ranges and the identified entities using the KPIs. The presentation of the assessment results may further include one or more weights associated with the one or more subsets of contributing factors for the KPIs that are editable by the user. The one or more weights according to the present disclosure include one or more conditions with numeric values that are applied to adjust the assessment results. For example, the conditions include actionable conditions such as hospital management, special care management, PCP operation, etc., and risk-adjustment conditions such as patient age, patient race, hypertension condition of the patient, etc. By adjusting the weights or conditions that contribute to the entity assessment, the identification of the outliers can be more accurate and meaningful in operational management. It should be appreciated that the above examples of the one or more weights are for illustrative purpose and the present disclosure is not intended to be limiting.

Metrics analyzing component 110 is configured to analyze the operation data of the entity (i.e., the PCP, hospital, etc.) and determine one or more healthcare-related metrics to assess the performance of the entity. Many factors impact the operation of a PCP including but not limited to healthcare-related factors, financial factors, legal factors, and unexpected cost. For example, rental cost of the office and legal expenses during the fiscal year may impact the operation performance of the PCP. Metrics analyzing component 110 filters the factors impacting the operation of the PCP and selects those factors that are healthcare related to construct the one or more metrics as KPIs to assess the performance of the PCP. As described above, with respect to a PCP, a total volume of expenditure patients spent with the PCP, a percentage of patient leakage from the PCP, and a percentage of avoidable cost the PCP is responsible for may be selected to assess the performance of the PCP. The above examples of determining the one or more healthcare-related metrics are for illustrative purpose. The present disclosure is not intended to be limiting. It should be appreciated that metrics analyzing component 110 may be configured to determine one or more metrics other than the healthcare-related factors to assess the performance of the entity.

Contributing factor collecting component 108 is configured to collect a plurality of factor candidates that contribute to the one or more selected metrics (i.e., KPIs). For example, the number of patients visiting a gastroenterologist group and the number of in-office procedures contribute to the total volume of expenditure patients. The contributing factor candidates of KPIs may be collected on a daily basis of the entity and classified into different categories. For a given KPI, the contribution of different factor candidates may be quantized to different degrees. For example, for the KPI of the total volume of expenditure patients, the number of patients visiting a PCP may contributes 40% to the KPI while the location of the PCP location may contributes 1% to the KPI. In some embodiments, one contributing factor candidate may contribute differently according to different KPIs. For example, the average age of the patients contributes more to the KPI of a percentage of avoidable cost than to the KPI of a total volume of expenditure patients. The above examples of the contributing factor candidates are for illustrative purpose. The present disclosure is not intended to be limiting. It should be appreciated that the contributing factor candidates may be obtained from all information related to the operation of the entity.

Data processing component 112 is configured to process a collection of healthcare records associated with the entity to assess the one or more healthcare-related metrics with respect to the entity. In some embodiments, the collection of healthcare records includes a set of values associated with the contributing factor candidates. The healthcare records may be collected on a temporal basis, for example, in the past fiscal year. In some embodiments, the healthcare records may be collected on a locale basis, for example, in the city of Washington D.C. In another embodiment, the healthcare records may be collected on the basis of a specific medical cohort, for example, the cohort of diabetes. In another embodiment, the healthcare records may be collected on the basis of a specific condition, for example, the patients born in 1950's. Further, the healthcare records may be collected on the basis of the combination of one or more conditions. The examples of the collection of healthcare records described above are for illustrative purpose. The present teaching is not intended to be limiting. It should be appreciated that the collection of healthcare records may be based on various criteria defined by the user.

Contributing factor selecting component 114 is configured to select one or more subsets of contributing factors from the contributing factor candidates for each healthcare-related metric (i.e., KPI). The information of the contributing factor candidates may be vast and vague. Thus, one or more feature selection algorithms or models may be employed to determine the most important contributing factors with respect to a given KPI. For example, ensemble learning and reinforcement learning can be used for the subset selection. However, the present disclosure is not intended to be limiting. Other techniques in machine learning and/or other methods in the statistics may also be applied for the subset selection.

Threshold configuring component 116 is configured to set one or more thresholds for the outlier detection. During the subset selection described above, one or more impact thresholds may be set with respect to the one or more healthcare-related metrics (i.e., KPIs). For example, for the KPI of the total volume of expenditure patients, an impact threshold to select the contributing factor may be set that the value associated with the contributing factor candidate (i.e., the quantized contributing degree) is equal to or great than 35%. In another example, for the KPI of the percentage of avoidable cost, an impact threshold to select the contributing factor may be set that the value associated with the contributing factor candidate (i.e., the quantized contributing degree) is equal to or great than 50%. Different KPIs may be configured with different impact thresholds. In some embodiments, the impact thresholds are adjustable in accordance with the availability of the amount of contributing factor candidates. By setting the thresholds for subset selection, the factors that contribute mostly to the KPIs are selected.

In some embodiments, threshold configuring component 116 is configured to set one or more outlier detection thresholds in accordance with the one or more healthcare-related metrics (i.e., KPIs). For example, for the total volume of expenditure patients, the outlier detection threshold is set to be equal to or greater than $1.6 million. That is, the entity with a total volume of expenditure patients exceeding the $1.6 million satisfies one condition of the outlier detection. In another example, for the percentage of patient leakage, the outlier detection threshold is set to be equal to or greater than 65%. That is, the entity with a percentage of patient leakage exceeding 65% satisfies another condition of the outlier detection. In yet another example, for the percentage of avoidable cost, the outlier detection threshold is set to be equal to or greater than 50%. That is, the entity with a percentage of avoidable cost exceeding 50% satisfies another condition of the outlier detection. It should be appreciated that the one or more outlier detection thresholds are not limited to the examples set forth above.

Outlier detecting component 118 is configured to identify the outliers out of a plurality of entities based on the one or more healthcare-related metrics (i.e., KPIs) and one or more the outlier detection thresholds. An entity is identified as an outlier based on the determination as to whether the entity satisfies the one or more outlier detection thresholds. The determination may be made based on any combinations of the one or more outlier detection thresholds.

Adjusting component 120 is configured to adjust the one or more subsets of contributing factors to reassess the one or more healthcare-related metrics (i.e., KPIs) with respect to the identified entity. Multiple triggering conditions may impact the subset selection of the contributing factors. Such triggering conditions may be considered to reassess the one or more healthcare-related metrics (i.e., KPIs) with respect to the identified outlier. For example, the patients of a group of cardiologists are mostly senior people. Therefore, the percentage of avoidable cost due to using the durable medical equipment (DME) oxygen on those patients is inevitably high. By contrast, the patients of a group of pediatrics are mostly infants or junior kids. The percentage of avoidable cost is low. While the threshold is universally set with respect to the KPI of avoidable cost, the identification results of the outliers may be biased. Adjusting component 120 may select one or more additional factors that contribute solely to a given KPI, or one or more given KPIs. For example, hypertension condition, DME oxygen usage, and cardio echo test usage contribute significantly to the percentage of avoiable cost while minor to the percentage of patient leakage. Adjusting component 120 adjusts the one or more subsets of contributing factors by considering the one or more additional factors to reassess the one or more healthcare-related metrics (i.e., KPIs) with respect to the identified outlier.

In some embodiments, the multiple triggering conditions may be classified into actionable conditions and risk-adjustment conditions. The actionable conditions may be related to the management of the PCP and the hospital. Recommendations can be made to the PCP and the hospital to improve the management to avoid being identified as the outliers. For example, the recommendations may include schedule regular follow-ups to the patients; provide special care managements to certain patients; research on previous care locations of the patients, etc. The risk-adjustment conditions may be related to the specialties associated with the identified outliers and/or the patient attributes due to the specialties associated with the identified outliers. For example, Asian Americans are at increased risk of getting diabetes. Therefore, the race of the patients may be an adjustable contributing factor. In another example, the age of the patients, the hypertension condition, the DME oxygen usage, or the cardio echo test usage may be adjustable contributing factors.

Suggesting component 122 is configured to modify one or more weights associated with the one or more subsets of contributing factors. For example, for the group of cardiologists that is identified as an outlier, suggesting component 112 adjusts the weights associated with the pre-selected contributing factors such as age, race, location, etc., and assigns new weights to the additional factors of hypertension condition, DME oxygen usage, and cardio echo test usage for reassessment. The modification of the one or more weights associated with the one or more subsets of contributing factors may be based on the attributes related to the identified outlier. In some embodiments, the modification of the one or more weights associated with the one or more subsets of contributing factors may be based on information associated with the identified outlier. For example, a relocation of the physician's office in the current year contributes significantly to the percentage of patient leakage, and therefore, the weight assigned to the location factor is adjusted for reassessment.

Memory 106 is configured to electronically stores information in an electronic storage media. Memory 206 may comprise one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. The electronic storage media of memory 206 may comprise one or both of system storage that is provided integrally (i.e., substantially non-removable) with the system and/or removable storage that is removably connectable to the system via, for example, a port (e.g., a USB port, a firewire port, etc.) or a drive (e.g., a disk drive, etc.). Memory 206 stores computer programs to be executed via a plurality of components 108, 110, 112, 114, 116, 118, 120 and 122.

Communication component 124 is configured to perform communications between processor 102 and other components of outlier detection server 100. In some embodiments, communication component 124 communicates with one or more databases accessible via a network to obtain the operation data associated with the entities and healthcare records. In another embodiment, communication component 124 communicates with the entities associated with the network to provide performance assessment results and recommendations to improve the performance. Communication component 124 is a physical component implemented on the computer, for example, a network interface controller (also known as a network interface card, network adapter, network interface, etc.). Communication component 124 may be a special expansion card plugged into a computer bus and operatively connected to processor 102. In some embodiment, communication component 124 implements an electronic circuitry required to communicate with the network using a specific physical layer and data link layer standard such as Ethernet, Fiber Channel, Wi-Fi or Token Ring. This provides a base for a full network protocol stack, allowing communication among small groups of computers on the same local area network (LAN) and large-scale network communications through routable protocols, such as Internet Protocol (IP). Communication component 124 may be both a physical layer and data link layer device because it provides physical access to a networking medium and a low-level addressing system for IEEE 802 and similar networks through the use of media access control (MAC) addresses that are uniquely assigned to network interfaces. The present teaching contemplates any techniques for communication including but not limited to hard-wired and wireless communications.

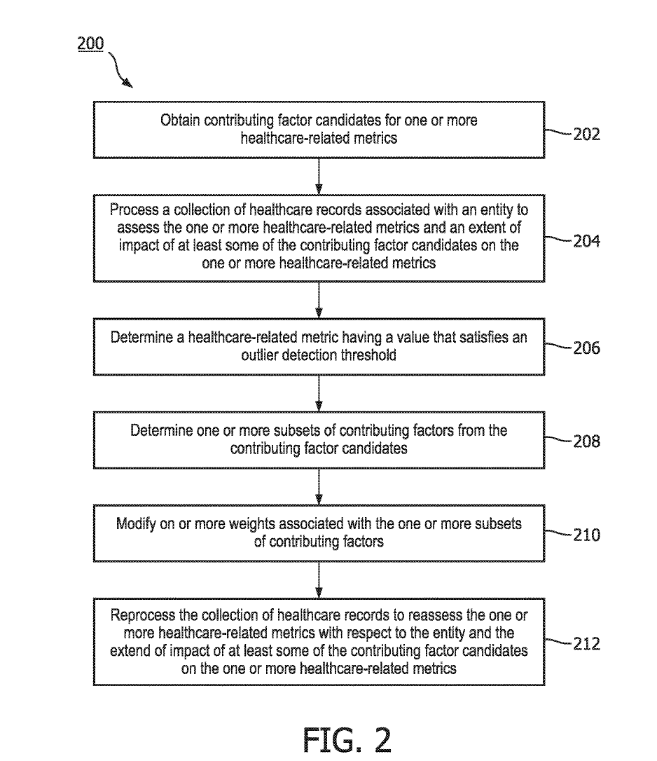

FIG. 2 illustrates an exemplary flowchart for facilitating computer-assisted healthcare-related outlier detection, in accordance with an embodiment of the present teaching. The operations of the illustrated process presented below are intended to be illustrative. In some embodiments, the process may be accomplished with one or more additional operations not described, and/or without one or more of the operations discussed. Additionally, the order in which the operations of the process as illustrated in FIG. 2 and described below is not intended to be limiting.

At operation 202, contributing factor candidates for one or more healthcare-related metrics are obtained. In some embodiments, operation 202 is performed by a contributing factor collecting component and a metrics analyzing component the same as or similar to contributing factor collecting component 108 and metrics analyzing component 110 (shown in FIG. 1 and described herein).

At operation 204, a collection of healthcare records associated with an entity is processed to assess the one or more healthcare-related metrics with respect to the entity and an extent of impact of at least some of the contributing factor candidates on the one more healthcare-related metrics. In some embodiments, operation 204 is performed by a data processing component the same as or similar to data processing component 112 (shown in FIG. 1 and described herein).

At operation 206, an outlier detection threshold for each of the one or more healthcare-related metrics is determined. In some embodiments, operation 206 is performed by a threshold configuring component the same as or similar to threshold configuring component 116 (shown in FIG. 1 and described herein).

At operation 208, one or more subsets of contributing factors from the contributing factor candidates are determined. In some embodiments, operation 208 is performed by a contributing factor selecting component the same as or similar to contributing factor selecting component 114 (shown in FIG. 1 and described herein).

At operation 210, one or more weights associated with the one or more subsets of contributing factors are modified. In some embodiments, operation 210 is performed by a suggesting component the same as or similar to suggesting component 122 (shown in FIG. 1 and described herein).

At operation 212, the collection of healthcare records are reprocessed to reassess the one or more healthcare-related metrics with respect to the entity and the extent of impact of at least some of the contributing factor candidates on the one or more healthcare-related metrics. In some embodiments, operation 212 is performed by an adjusting component the same as or similar to adjusting component 120 (shown in FIG. 1 and described herein).

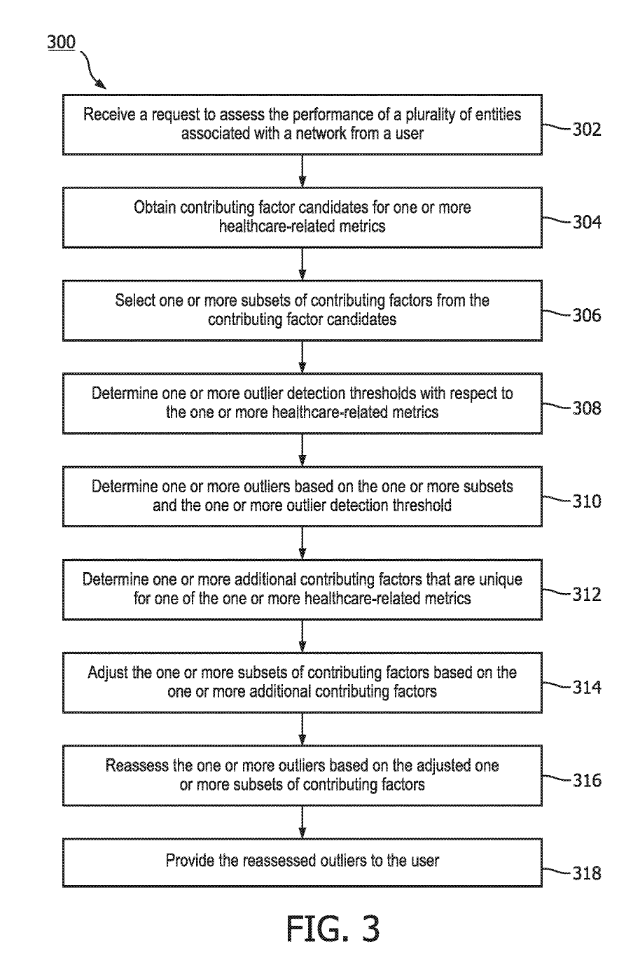

FIG. 3 illustrates another exemplary flowchart for facilitating computer-assisted healthcare-related outlier detection, in accordance with an embodiment of the present teaching. The operations of the illustrated process presented below are intended to be illustrative. In some embodiments, the process may be accomplished with one or more additional operations not described, and/or without one or more of the operations discussed. Additionally, the order in which the operations of the process as illustrated in FIG. 3 and described below is not intended to be limiting.

At operation 302, a request to assess the performance of a plurality of entities associated with a network is received from a user. In some embodiments, operation 302 is performed by a user interface the same as or similar to user interface 104 (shown in FIG. 1 and described herein).

At operation 304, contributing factor candidates for one or more healthcare-related metrics are obtained. In some embodiments, operation 304 is performed by a contributing factor collecting component the same as or similar to contributing factor collecting component 108 (shown in FIG. 1 and described herein).

At operation 306, one or more subsets of contributing factors are selected from the contributing factor candidates. In some embodiments, operation 306 is performed by a contributing factor selecting component the same as or similar to contributing factor selecting component 114 (shown in FIG. 1 and described herein).

At operation 308, one or more outlier detection thresholds with respect to the one or more healthcare-related metrics are determined. In some embodiments, operation 208 is performed by a threshold configuring component the same as or similar to threshold configuring component 116 (shown in FIG. 1 and described herein).

At operation 310, one or more outliers are determined based on the one or more subsets and the one or more outlier detection thresholds. In some embodiments, operation 310 is performed by an outlier detecting component the same as or similar to outlier detecting component 118 (shown in FIG. 1 and described herein).

At operation 312, one or more additional contributing factors that are unique for one of the one or more healthcare-related metrics are determined. In some embodiments, operation 312 is performed by a suggesting component the same as or similar to suggesting component 122 (shown in FIG. 1 and described herein).

At operation 314, the one or more subsets of contributing factors are adjusted based on the one or more additional contributing factors. In some embodiments, operation 314 is performed by an adjusting component the same as or similar to adjust component 120 (shown in FIG. 1 and described herein).

At operation 316, the one or more outliers are reassessed based on the adjusted one or more subsets, operation 316 is performed by an adjusting component the same as or similar to adjust component 120 (shown in FIG. 1 and described herein).

At operation 318, the reassessed one or more outliers are provided to the user. In some embodiments, operation 318 is performed by a suggesting component the same as or similar to suggesting component 122 (shown in FIG. 1 and described herein).

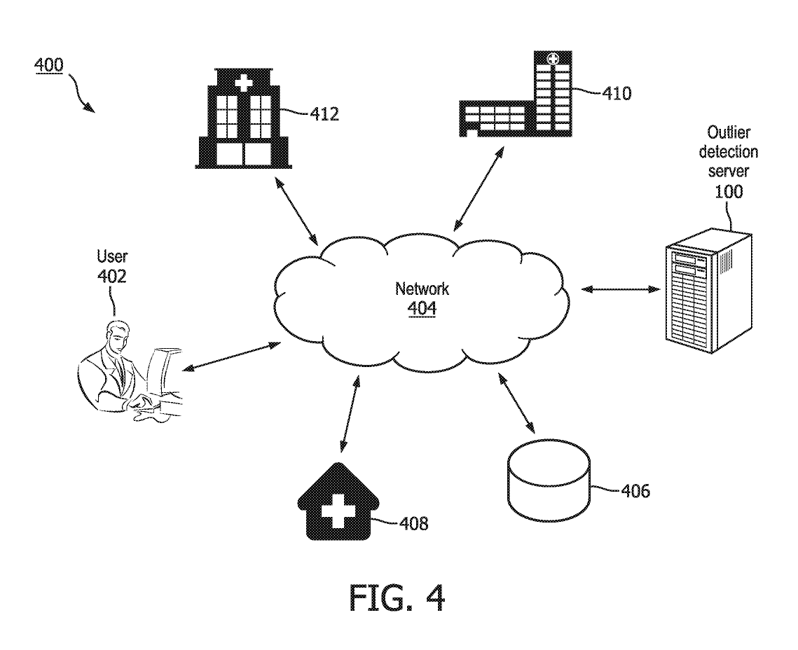

FIG. 4 illustrates an exemplary system for facilitating computer-assisted healthcare-related outlier detection, in accordance with another embodiment of the present teaching. The system for facilitating computer-assisted healthcare-related outlier detection 400 comprises at least a user 402 operating a user device, an outlier detection server 100, at least one database 406, a network 404, and one or more entities 408, 410 and 412.

User 402 according to the present disclosure may be a third party that performs entity assessment and supervising. User 402 may operate one or more user devices implemented with an application for facilitating computer-assisted healthcare-related outlier detection. User 402 receives information related to one or more entities 408, 410 and 412 associated with network 404 and generates one or more models to assess the performance via the user device. The assessment results with one or more outliers identified by outlier detection server 100 and scenarios or recommendations to the outliers to improve the performance are presented to user 402 via the user device. User 402 communicates with outlier detection server 100 via the user device to execute the computer programs for outlier detection. The user device may be configured to retrieve information from database 406 and one or more entities 408, 410 and 412 for performance assessment.

Outlier detection server 100 is configured to be a backend server for facilitating computer-assisted healthcare-related outlier detection. Outlier detection server 100 receives instructions from the user device and executes the implemented computer programs in response to the instructions. Outlier detection server 100 is configured to be capable of communicating with database 406 and one or more entities 408, 410 and 412 via network 404. The configuration of outlier detection server 100 is illustrated in FIG. 1 and described above. It should be appreciated that the present teaching is not intended to be limiting. Outlier detection server 100 may be a general computing server or a dedicated computing server. Outlier detection server 100 may be configured to provide backend support for any healthcare resource management system. In some embodiments, outlier detection server 100 may also be configured to be interoperable across other healthcare resource management servers.

Database 406 is configured to store healthcare-related records associated with the patients. Such healthcare-related records may be collected from one or more entities 408, 410 and 412 via the network. Database 108 may be network storage and/or cloud storage directly connected to network 404. In some embodiments, database 406 may be a backend database of outlier detection server 100. In other embodiments, database 406 may serve as backend storage of outlier detection server 100 as well as network storage and/or cloud storage. Database 406 may be scheduled to automatically retrieve information from one or more entities 408, 410 and 412. In some embodiments, database 406 may also update the information in response to a request from the user device and/or outlier detection server 100.

Network 404 is configured to transmit information among a plurality of components connected to the network. For example, network 404 transmits a request from the user device to outlier detection server 100, and the assessment results from outlier detection server 100 to the user device. Network 404 may be a single network or a combination of multiple networks. For example, network 106 may be a local area network (LAN), a wide area network (WAN), a public network, a private network, a proprietary network, a Public Telephone Switched Network (PSTN), the Internet, a wireless communication network, a virtual network, and/or any combination thereof.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the description provided above provides detail for the purpose of illustration based on what is currently considered to be the most practical and preferred embodiments, it is to be understood that such detail is solely for that purpose and that the disclosure is not limited to the expressly disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A system for facilitating computer-assisted healthcare-related outlier detection via automated threshold-based contributing factor detection, the system comprising:
at least one processor configured by machine-readable instructions to:
obtain contributing factor candidates for one or more healthcare-related metrics;
process, based on the contributing factor candidates, a collection of healthcare records associated with an entity to assess the one or more healthcare-related metrics with respect to the entity and an extent of impact of at least some of the contributing factor candidates on the one or more healthcare-related metrics, the collection of healthcare records including a set of values associated with each of the contributing factor candidates;
determine, based on the processing of the collection of healthcare records, a healthcare-related metric having a value that satisfies an outlier detection threshold associated with the healthcare-related metric;
determine, based on the processing of the collection of healthcare records, one or more subsets of contributing factors from the contributing factor candidates, wherein the one or more subsets of contributing factors include one or more values that satisfy an impact threshold associated with the healthcare-related metric;
modify one or more weights associated with the one or more subsets of contributing factors; and
reprocess, based the one or more modified weights, the collection of healthcare records to reassess the one or more healthcare-related metrics with respect to the entity and the extent of impact of at least some of the contributing factor candidates on the one or more healthcare-related metrics.

2. The system of claim 1, wherein the at least one processor is further configured by machine-readable instructions to:
cause, on a user interface, presentation of the one or more subsets of contributing factors, the one or more values associated therein, and the extent of impact of the one or more subsets of contributing factors on the one or more healthcare-related metrics to be prioritized over at least one or more other subsets of contributing factors responsive to the one or more other subsets of contributing factors, wherein the one or more other subsets of contributing factors satisfy the impact thresholds associated with the respective healthcare-related metrics.

3. The system of claim 1, wherein the at least one processor modifies the one or more weights without further user input subsequent to the determination of the outlier detection threshold for each of the one or more healthcare-related metrics and the one or more subsets of contributing factors, and wherein the at least one processor is further configured by machine-readable instructions to:
cause, on a user interface, presentation of the assessment and reassessment of the one or more healthcare-related metrics with respect to the entity and the extent of impact of at least some of the contributing factor candidates to the one or more healthcare-related metrics.

4. The system of claim 1, wherein the at least one processor is further configured by machine-readable instructions to:
generate one or more suggested weight values for the one or more subsets of contributing factors based on the extent of impact of the one or more subsets of contributing factors on the healthcare-related metrics,
wherein the at least one processor modifies the one or more weights associated with the one or more subsets of contributing factors based on the one or more suggested weight values.

5. The system of claim 1, wherein the impact threshold for the healthcare-related metric is a relative threshold of impact on the healthcare-related metric relative to an impact of one or more other subsets of contributing factors on the healthcare-related metric.

6. The system of claim 1, wherein the impact threshold for the healthcare-related metric is a user-defined impact threshold.

7. The system of claim 1, wherein the outlier detection threshold for the healthcare-related metric is a user-defined outlier detection threshold.

8. A method implemented on a system for facilitating computer-assisted healthcare-related outlier detection via automated threshold-based contributing factor detection, the method comprising:
obtaining, with at least one processor, contributing factor candidates for one or more healthcare-related metrics;
processing, with the at least one processor, based on the contributing factor candidates, a collection of healthcare records associated with an entity to assess the one or more healthcare-related metrics with respect to the entity and an extent of impact of at least some of the contributing factor candidates on the one or more healthcare-related metrics, the collection of healthcare records including a set of values associated with each of the contributing factor candidates;
determine, based on the processing of the collection of healthcare records, a healthcare-related metric having a value that satisfies an outlier detection threshold associated with the healthcare-related metric;
determine, based on the processing of the collection of healthcare records, one or more subsets of contributing factors from the contributing factor candidates, wherein the one or more subsets of contributing factors include one or more values that satisfy an impact threshold associated with the healthcare-related metric; modifying, with the at least one processor, one or more weights associated with the one or more subsets of contributing factors; and
reprocessing, with the at least one processor, based the one or more modified weights, the collection of healthcare records to reassess the one or more healthcare-related metrics with respect to the entity and the extent of impact of at least some of the contributing factor candidates on the one or more healthcare-related metrics.

9. The method of claim 8, further comprising:
causing, with the at least one processor, on a user interface, presentation of the one or more subsets of contributing factors, the one or more values associated therein, and the extent of impact of the one or more subsets of contributing factors on the one or more healthcare-related metrics to be prioritized over at least one or more other subsets of contributing factors responsive to the one or more other subsets of contributing factors, wherein the one or more other subsets of contributing factors satisfy the impact thresholds associated with the respective healthcare-related metrics.

10. The method of claim 8, wherein the at least one processor modifies the one or more weights without further user input subsequent to the determination of the outlier detection threshold for each of the one or more healthcare-related metrics and the one or more subsets of contributing factors, and wherein the method further comprising:
causing, with the at least one processor, on a user interface, presentation of the assessment and reassessment of the one or more healthcare-related metrics with respect to the entity and the extent of impact of at least some of the contributing factor candidates to the one or more healthcare-related metrics.

11. The method of claim 8, further comprising:
generating, with the at least one processor, one or more suggested weight values for the one or more subsets of contributing factors based on the extent of impact of the one or more subsets of contributing factors on the healthcare-related metrics,
wherein the at least one processor modifies the one or more weights associated with the one or more subsets of contributing factors based on the one or more suggested weight values.

12. The method of claim 8, wherein the impact threshold for the healthcare-related metric is a relative threshold of impact on the healthcare-related metric relative to an impact of one or more other subsets of contributing factors on the healthcare-related metric.

13. The method of claim 8, wherein the impact threshold for the healthcare-related metric is a user-defined impact threshold.

14. The method of claim 8, wherein the outlier detection threshold for the healthcare-related metric is a user-defined outlier detection threshold.

15. A system for facilitating computer-assisted healthcare-related outlier detection via automated threshold-based contributing factor detection, the system comprising:
means for obtaining, with at least one processor, contributing factor candidates for one or more healthcare-related metrics;
means for processing, with the at least one processor, based on the contributing factor candidates, a collection of healthcare records associated with an entity to assess the one or more healthcare-related metrics with respect to the entity and an extent of impact of at least some of the contributing factor candidates on the one or more healthcare-related metrics, the collection of healthcare records including a set of values associated with each of the contributing factor candidates;
means for determining, with the at least one processor, based on the processing of the collection of healthcare records, a healthcare-related metric having a value that satisfies an outlier detection threshold associated with the healthcare-related metric;
means for determining, with the at least one processor, based on the processing of the collection of healthcare records, one or more subsets of contributing factors from the contributing factor candidates, wherein the one or more subsets of contributing factors include one or more values that satisfy an impact threshold associated with the healthcare-related metric;
means for modifying, with the at least one processor, one or more weights associated with the one or more subsets of contributing factors; and
means for reprocessing, with the at least one processor, based the one or more modified weights, the collection of healthcare records to reassess the one or more healthcare-related metrics with respect to the entity and the extent of impact of at least some of the contributing factor candidates on the one or more healthcare-related metrics.

16. The system of claim 15, further comprising:
means for causing, with the at least one processor, on a user interface, presentation of the one or more subsets of contributing factors, the one or more values associated therein, and the extent of impact of the one or more subsets of contributing factors on the one or more healthcare-related metrics to be prioritized over at least one or more other subsets of contributing factors responsive to the one or more other subsets of contributing factors, wherein the one or more other subsets of contributing factors satisfy the impact thresholds associated with the respective healthcare-related metrics.

17. The system of claim 15, wherein the at least one processor modifies the one or more weights without further user input subsequent to the determination of the outlier detection threshold for each of the one or more healthcare-related metrics and the one or more subsets of contributing factors, and wherein the system further comprises:
means for causing, with the at least one processor, on a user interface, presentation of the assessment and reassessment of the one or more healthcare-related metrics with respect to the entity and the extent of impact of at least some of the contributing factor candidates to the one or more healthcare-related metrics.

18. The system of claim 15, further comprising:
means for generating, with the at least one processor, one or more suggested weight values for the one or more subsets of contributing factors based on the extent of impact of the one or more subsets of contributing factors on the healthcare-related metrics,
wherein the at least one processor modifies the one or more weights associated with the one or more subsets of contributing factors based on the one or more suggested weight values.

19. The system of claim 15, wherein the impact threshold for the healthcare-related metric is a relative threshold of impact on the healthcare-related metric relative to an impact of one or more other subsets of contributing factors on the healthcare-related metric.

20. The system of claim 15, wherein outlier detection threshold for the healthcare-related metric is a user-defined outlier detection threshold.
